(19) United States
(12) Patent Application Publication
(10) Pub. No.: US 2018/0367845 A1
(43) Pub. Date: Dec. 20, 2018

(54) DETECTING INACTIVITY LEVELS ASSOCIATED WITH MULTIMEDIA CONTENT CONSUMPTION

(71) Applicant: THOMSON Licensing, Issy-les-Moulineaux (FR)

(72) Inventors: Anita TRAN, Pasadena, CA (US); Azin ASHKAN, San Jose, CA (US); Marc JOYE, Palo Alto, CA (US); Jaideep CHANDRASHEKAR, San Francisco, CA (US); Akshay PUSHPARAJA, Mountain View, CA (US); Swayambhoo JAIN, Sunnyvale, CA (US); Shi ZHI, Urbana, IL (US); Junyang QIAN, Stanford, CA (US)

(73) Assignee: THOMSON LICENSING, Issy-les-Moulineaux (FR)

(21) Appl. No.: 15/780,228

(22) PCT Filed: Dec. 1, 2015
(86) PCT No.: PCT/US2015/063093

§ 371 Date: May 30, 2018

(51) Int. Cl. H04N 21/442; H04N 21/4223; H04N 21/437; H04N 21/266

(52) U.S. Cl. CPC H04N 21/44218; H04N 21/4223; H04N 21/44204; H04N 21/266; H04N 21/437

(57) ABSTRACT

Interactions with a multimedia content provider are tracked and communication is made with a physical activity tracking device to obtain movement information. The interactions and physical activity level provide insight as to a length of time a user has been continuously watching multimedia content. When a level of inactivity exceeds a threshold, access to multimedia content is adjusted, for example, by limiting access to the multimedia content and/or displaying a notification to the user regarding their level of inactivity.

### TECHNICAL FIELD

The present principles relate to multimedia devices. In particular, the present principles relate to managing multimedia content in view of inactivity levels.

### BACKGROUND

Video on demand (“VOD”) allows users to watch or listen to multimedia content of their choosing at any time that is convenient for the user. VOD services may be used in conjunction with mobile devices, such as laptops, mobile phones, or tablets.

### SUMMARY

As noted above, VOD allows users to watch or listen to multimedia content of their choosing at any time that is convenient for them. The advent of readily available media services on any device has resulted in prolonged, uninterrupted viewing (“binge-watching”). Bing-watching has been identified as a behavior of many users that may have detrimental health impacts including, but not limited to, visual and mental fatigue, neck and back strain, and other side effects relating to a sedentary lifestyle. For example, research shows that binge-watching more likely leads to depression and loneliness. Harmful binge watching may also lead to overeating and alcohol abuse. Nevertheless, while the use of VOD continues to expand, consumers are also trending toward a more health conscious lifestyle. Many people make an effort to stay active and set personal fitness goals. Unfortunately, even health conscious consumers may find it difficult to abstain from the excess of multimedia entertainment that is readily available.

In view of the foregoing, disclosed herein are an apparatus, method, and non-transitory computer readable media for controlling multimedia content consumption. In one example, an apparatus can comprise an interface and at least one processor. The at least one processor can be configured to: track continuous interactions with a multimedia content provider; communicate, using the interface, with a physical activity tracking device to obtain movement information; and, determine whether a level of inactivity exceeds a threshold based on the continuous interactions or the movement information. Moreover, when the level of inactivity exceeds a threshold, the at least one processor can also be configured to adjust access to multimedia content from the multimedia content provider in accordance with the level of inactivity.

In a further aspect, the physical activity tracking device can include at least one of a camera and a motion detector. In yet another aspect, the at least one processor can be further configured to display feedback information regarding the level of inactivity. To adjust access to multimedia content, the at least one processor can be configured to limit access to the multimedia content until the level of inactivity falls below the threshold. To track the continuous interactions, the at least one processor can be further configured to track a time duration of video playback or track a number of program episodes played back continuously. Moreover, the threshold can be configurable based at least partially on demographic data or customized data.

In yet another example, a method is provided. The method can comprise: tracking continuous interactions with a multimedia content provider; communicating with a physical activity tracking device to obtain movement information; and, determining whether a level of inactivity exceeds a threshold based on the continuous interactions or the movement information. Moreover, when the level of inactivity exceeds the threshold, the method can comprise adjusting access to multimedia content from the multimedia content provider in accordance with the level of inactivity.

In a further example, the method can further comprise displaying feedback information regarding the level of inactivity; adjusting access to multimedia content; and restricting access to the multimedia content until the level of inactivity falls below the threshold. Tracking the continuous interactions can further comprise tracking the time duration of video playback. Tracking the continuous interactions can further comprise tracking a number of program episodes played back continuously.

In another aspect, a non-transitory computer readable medium can have instructions stored therein, which upon execution, cause at least one processor to: track continuous interactions with a multimedia content provider; communicate, using an interface, with a physical activity tracking device to obtain movement information; determine whether a level of inactivity exceeds a threshold based on the continuous interactions or the movement information; and when the level of inactivity exceeds the threshold, adjust access to multimedia content from the multimedia content provider in accordance with the level of inactivity.

Thus, the techniques disclosed herein can track a user's viewing activity and/or physical activity. Access to multimedia content can be blocked, when the physical inactivity and/or viewing activity exceeds a threshold. Blocking access to media content can force a user to become more physically active before further content consumption is allowed. The aspects, features and advantages of the present principles will be appreciated when considered with reference to the following description of examples and accompanying figures. The following description does not limit the present principles; rather, the scope of the present principles is defined by the appended claims and equivalents.

### BRIEF DESCRIPTION OF THE DRAWINGS

FIG. 1 is an exemplary system in accordance with an embodiment of the present principles.

FIG. 2 is a flow diagram of an example method in accordance with an embodiment of the present principles.

FIG. 3 is a working example in accordance with an embodiment of the present principles.

FIG. 4 is yet another working example in accordance with an embodiment of the present principles.

### DETAILED DESCRIPTION

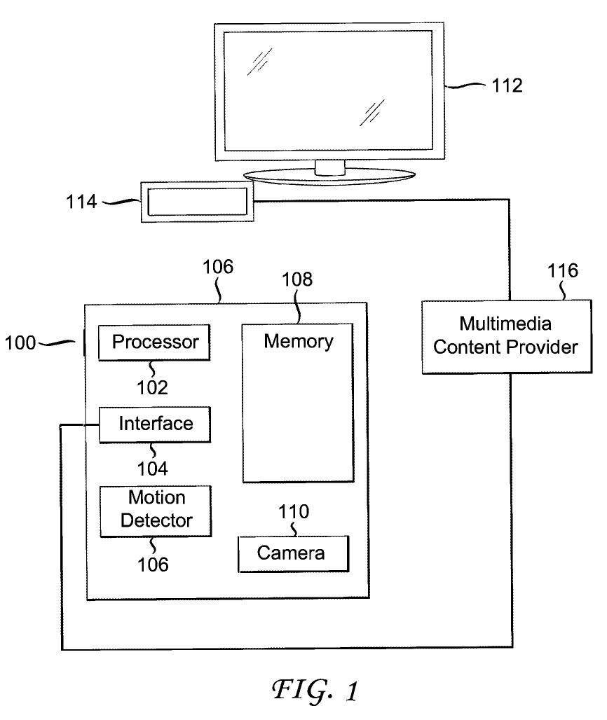

FIG. 1 presents a schematic diagram of an illustrative computer apparatus 100 that can be used in accordance with an embodiment of the present principles. Computer apparatus 100 can comprise, as non-limiting examples, any device capable of processing instructions and transmitting data to and from other computers, including a laptop or a full-sized personal computer. Computer apparatus 100 can include all the components normally used in connection with a computer. For example, it can have a keyboard and mouse and/or various other types of input devices, such as pen-inputs, joysticks, buttons, touch screens, etc.

Furthermore, computer apparatus 100 can be a mobile device that includes, but is not limited to, a smart phone or tablet PC. In this instance, computer apparatus 100 can include all the components normally used in connection with mobile devices. For example, computer apparatus 100 can have a touch screen display, a physical keyboard, a virtual touch screen keyboard, a camera, a speaker, a global positioning system or a microphone.

Computer apparatus 100 can also contain at least one processor that can be arranged as different processing cores. For ease of illustration, one processor 102 is shown in FIG. 1, but it is understood that multiple processors can be employed simultaneously. Processor 102 can be any number of well-known processors, such as processors from Intel® Corporation. In another example, processor 102 can be an application specific integrated circuit (“ASIC”). Processor 102 can be implemented as a hardware processor, a digital signal processor (“DSP”), an ASIC, a field programmable gate array (“FPGA”) or other programmable logic devices, a discrete gate or transistor logic device, a discrete hardware component or any suitable combination of processing circuitry. Processor 102 can also be implemented as a combination of computation devices, such as a combination of a DSP and a microprocessor, a plurality of microprocessors, one or more microprocessors in communication with the DSP or any other such configuration.

Memory 108 can be any type of memory capable of storing information accessible by processor 102 including, but not limited to, a memory card, read only memory (“ROM”), random access memory (“RAM”), as well as other write-capable and read-only memories. Computer apparatus 100 can include different combinations of the foregoing, whereby different portions of the instructions and data are stored on different types of media.

In another example, memory 108 can be a non-transitory computer readable medium that can include any computer readable media with the exception of a transitory, propagating signal. Examples of non-transitory computer readable media can include one of many physical media such as, for example, electronic, magnetic, optical, electromagnetic or semiconductor media. More specific examples of suitable non-transitory computer-readable media include, but are not limited to, a portable magnetic computer diskette such as floppy diskettes or hard drives, an erasable programmable read-only memory, a portable compact disc or other storage devices that can be coupled to computer apparatus 100 directly or indirectly. The non-transitory computer readable media can also include any combination of the foregoing and/or other devices as well. While only one memory is shown in FIG. 1, computer apparatus 100 can actually comprise additional memories that may or may not be stored within the same physical housing or location.

Network interface device 104 can include hardware components (e.g., chipsets, controllers, antennas, etc.) and/or software that allow computer apparatus 100 to transmit, and/or receive data. Network interface device 104 can support one or more network interfaces including, but not limited to, Wi-Fi™, worldwide interoperability for microwave access (“WiMAX™”), 3rd generation mobile telecommunications (“3G”), 4th generation mobile telecommunications (“4G”), Global Standard for Mobile (“GSM”), code division multiple access (“CDMA”), time division multiple access (“TDMA”), Ethernet, special protocols proprietary to one or more companies, and various combinations of the foregoing, all by way of example and not by limitation. In addition, network interface device 104 can support short range wireless protocols, such as Bluetooth™ or Near Field Communication (“NFC”).

Motion detector 106 can be any detector such as, but not limited to: accelerometers, gyroscopes, magnetometers, proximity sensors and any combination thereof. For example, in the case of an accelerometer, acceleration forces can be measured to determine movement or vibrations, such as static, dynamic and the like. Data from motion detector 106 can spike if a device is moved, but the data typically remains constant if a device is unmoved. Accordingly, processor 102 can use data from motion detector 106 to detect movement of the device.

Camera 110 can be any camera having any amount of megapixels, such as smartphone cameras, video cameras, single chip cameras and any combination thereof. Camera 110 can further include image sensors, such as semiconductor charge-coupled devices (CCD), active pixel sensors in complementary metal-oxide-semiconductor (CMOS), or N-type metal-oxide-semiconductor (NMOS, Live MOS) technologies. Camera 110 can have also have any features, such as, but not limited to: light emitting diode (LED) flash, autofocus, digital image stabilization, digital zoom, face detection, geo-tagging, high dynamic range (HDR) capture, panorama, and touch focus. Moreover, camera 110 can include accessories, such as lenses, power supplies, clocks and the like. Camera 110 can be configured to detect and convey information that constitutes an image in any way, such as, for example, converting light into electric charges that are processed into electronic signals. The images captured by camera 110 can be used by processor 102 to determine movement of a user. In one example, processor 102 can identify a rate of change in the pixels of images captured by camera 110. In turn, processor 102 can determine that computer apparatus 100 is moving when the rate of change exceeds a threshold.

Set top box 114 can comprise suitable circuitry to read signals from multimedia content provider 116 and output displayable information to display 112. Set top box 114 can be a cable converter or digital television adapter. The source of the signal from multimedia content provider 116 into set top box 114 can include, but is not limited to, an Ethernet cable, a satellite dish, a coaxial cable, a telephone line or broadband over power lines. Set top box 114 can be configured to access multiple television delivery methods including, but not limited to, terrestrial, cable, Internet, satellite or a combination of the foregoing, and can also be enabled to access VOD services provided by multimedia content provider 116. Set top box 114 can connect to display 112 in a wired or wireless configuration. In a wired configuration, set top box 114 can be connected to display 112 using, for example, a High Definition Multimedia Interface (“HDMI”) port.

Multimedia content provider 116 can transmit content to computer apparatus 100 and set top box 114. The system can provide broadcast video service, VOD content and other interactive features, which may be delivered using Internet Protocol television (“IPTV”). Computer apparatus 100 can track continuous interactions with multimedia content provider 116. Such continuous interactions can include, for example, binge-watching or channel surfing.

Display 112 can include, but is not limited to, a cathode ray tube (CRT), liquid crystal display (LCD), plasma screen monitor, light emitting diodes (LED), TV, projector, or any other electronic device that is operable to display information. In another example, display 112 can be integrated with computer apparatus 100.

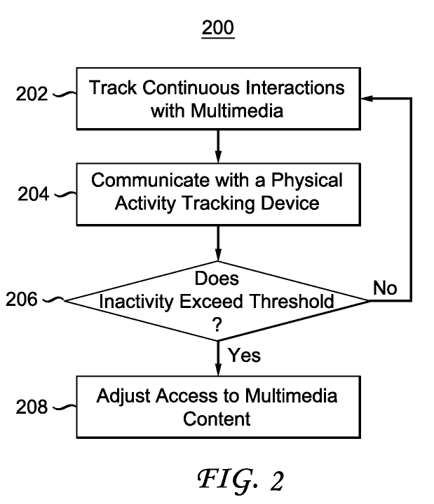

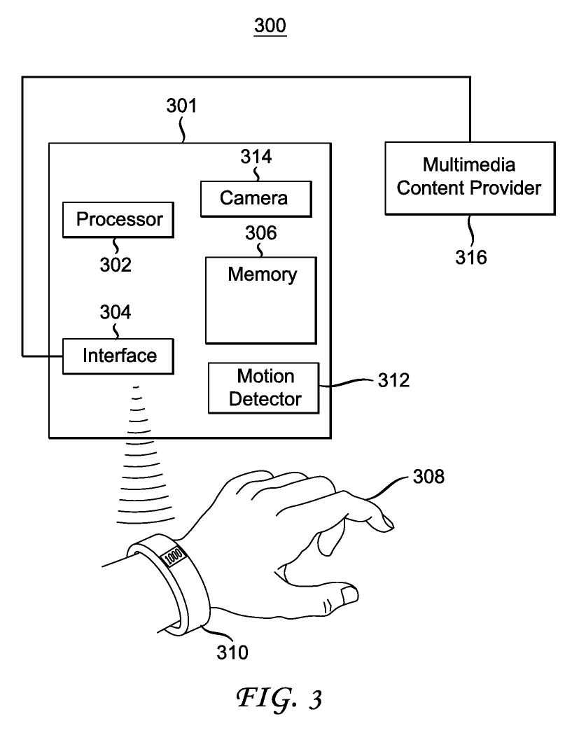

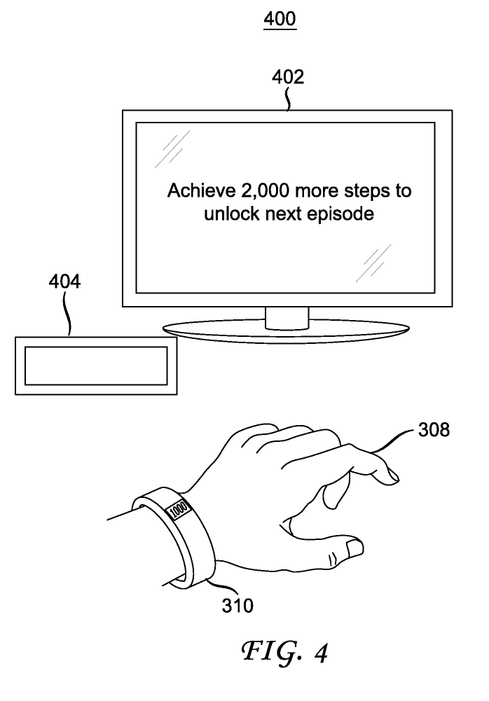

Working examples of the techniques herein are shown in FIGS. 2-4. In particular, FIG. 2 illustrates a flow diagram of an exemplary method 200 of an embodiment of the present principles for controlling media content. FIGS. 3 and 4 show working examples 300 and 400 in accordance with embodiments of the present principles. The actions shown in FIGS. 3 and 4 will be discussed below with regard to the flow diagram in FIG. 2.

Referring to FIG. 2, an exemplary method from the perspective of an apparatus (e.g., computer apparatus 100) is shown. In block 202, continuous interactions with multimedia can be tracked. In the working example of FIG. 3, a mobile device 301, with a processor 302, network interface device 304 and a memory 306 is shown. The mobile device 301 is shown communicating with a multimedia content provider 316. Processor 302 can determine whether the user of mobile device 301 is currently watching or attempting to watch multimedia content.

Referring back to FIG. 2, communication with a physical activity tracking device can be established, as shown in block 204. Referring back to FIG. 3, mobile device 301 is shown communicating with a wearable physical tracking device 310. The wearable physical tracking device 310 shown in FIG. 3 can contain sensors that track fitness-related metrics, such as distance walked or run, or number of steps walked. In the example of FIG. 3, wearable physical tracking device 310 identifies that user 308 has walked 1000 steps in the last twenty-four hours. This information can be communicated wirelessly to mobile device 301 using a short range wireless protocol (e.g., Bluetooth®, Bluetooth® Smart, Near Field Communication, etc.). In the example of FIG. 3, processor 302 communicates, via network interface device 304, with wearable physical tracking device 310 to obtain movement information (e.g., user walked 1000 steps). In another example of an embodiment, the physical tracking device can be a camera 314 and/or motion detector 312. In this instance, mobile device 301 can track fitness-related metrics internally using internal protocols.

Referring back to FIG. 2, it is determined whether an inactivity level exceeds a threshold, as shown in block 206. If the inactivity level does exceed a threshold, as shown in block 208, access to the multimedia content can be adjusted. Otherwise, the tracking can continue in block 202. In one example, prior to obtaining the movement information, processor 302 of FIG. 3 can first be configured to set-up preliminary data settings. Such data settings may be standard health and fitness guidelines (e.g., USDA food pyramids, WHO food recommendations, etc.), personal information (e.g., gender, age, weight, or height), personal goals (e.g., walk more than 1000 steps in one day) warnings (e.g., warn me if I haven't walked more than 1000 steps in one day), recommendations (e.g., recommend how many steps to take in one day to meet at least standard health and fitness guidelines, based at least on my personal information), and any combination thereof. It is understood that the data settings discussed herein are for illustrative purposes and that any type of settings can be configurable. Accordingly, based on the preliminary data settings, processor 302 can set an inactivity threshold.

In another example, a threshold can be a level of multimedia activity, such as, a number of on-demand content watched continuously (e.g., a number of episodes watched continuously) or a number of hours spent watching broadcast or on-demand television. This threshold can also be configurable. Thus, a level of inactivity can be determined based on continuous interaction with multimedia content provider 316 and/or the movement information received from wearable physical tracking device 310. As noted above, in the case of continuous interaction with multimedia content, the threshold may be exceeded, when there has been continuous playback activity beyond a set threshold (e.g. continuous playback activity beyond a time duration or number of episodes). In the case of movement information, the threshold may be exceeded when the level of inactivity exceeds a threshold. For example, the number of steps obtained from wearable physical tracking device 310 may fall below a configured threshold (e.g., did not meet personal goal of greater than 1000 steps), or may fall below a threshold predetermined based on demographic data (e.g., the amount of steps considered healthy for the average male having same height and weight is greater than 1000 steps).

Referring back to FIG. 2, when the level of inactivity exceeds a threshold, access to multimedia content can be adjusted in accordance with the level of inactivity, as shown in block 208. Referring back to FIG. 3, a command to prevent access to further multimedia content can be communicated by mobile device 301 to multimedia content provider 316. In turn, multimedia content provider 316 can halt all access until mobile device 301 acknowledges that the physical activity threshold or the viewing threshold is satisfied. In another example, multimedia content access can be adjusted locally within mobile device 301 without notifying multimedia content provider 316. In this instance, access to content will be prevented within mobile device 301.

In another example, mobile device 301 can prevent access to multimedia content locally and can transmit a command to prevent access to a set-top box, such as set top box 404 of FIG. 4. Referring now to FIG. 4, a working example 400 of adjusting access to multimedia content is shown. In this example, set top box 404 prevents access to multimedia content based on a received command. In turn, display 402 can provide feedback to user 308 about time spent consuming content and/or about the level of inactivity. The feedback can be in the form on an on-screen indicator (e.g., you are only at 30% of your daily step goal). The feedback can also be in the form of a dedicated page where user 308 can view a visualization of the user's consumption data and trends (e.g., time spent watching videos throughout the day, week, or month is displayed on a graph or calendar). However, it is understood that the feedback can be of any type and that the examples herein are merely illustrative. In the example of FIG. 4, display 402 provides feedback regarding how many more steps are required to unlock an episode. Thus, when the user meets the required level of activity by, for example, achieving 2,000 more steps, access to the next episode will be granted.

Advantageously, the above-described techniques allow users to configure their access to multimedia content in a controlled manner. That is, users can configure their devices, such as mobile devices, to place limits on multimedia content based on viewing habits or level of activity. In this regard, a device can prevent access to content, when viewing habits and activity levels do not meet a certain standard. In turn, users are encouraged to be more active.

Although the present principles herein have been described with reference to particular examples, it is to be understood that these examples are merely illustrative of the present principles. It is therefore to be understood that numerous modifications can be made to the examples and that other arrangements can be devised without departing from the scope of the present principles as defined by the appended claims. Furthermore, while particular processes are shown in a specific order in the appended drawings, such processes are not limited to any particular order unless such order is expressly set forth herein. Rather, various steps can be handled in a different order or simultaneously, and steps can be omitted or added.

1. An apparatus comprising:
an interface for communicating; and
at least one processor configured to:
track interactions with a multimedia content provider;
communicate, using the interface, with a physical activity tracking device to obtain movement information;
determine whether a level of inactivity exceeds a threshold based on the interactions and the movement information; and
when the level of inactivity exceeds the threshold, adjust access to multimedia content from the multimedia content provider in accordance with the level of inactivity.

2. The apparatus of claim 1, wherein the physical activity tracking device includes at least one of a camera and a motion detector.

3. The apparatus of claim 1, wherein the at least one processor is further configured to display feedback information regarding the level of inactivity.

4. The apparatus of claim 1, wherein to adjust access to multimedia content the at least one processor is configured to limit access to the multimedia content until the level of inactivity falls below the threshold.

5. The apparatus of claim 1, wherein to track the continuous interactions, the at least one processor is further configured to track a time duration of video playback.

6. The apparatus of claim 1, wherein to track the interactions. the at least one processor is further configured to track a number of program episodes played back.

7. The apparatus of claim 1, wherein the threshold is configurable based at least partially on demographic data or customized data.

8. A method comprising:
tracking, using at least one processor, interactions with a multimedia content provider;
communicating, using an interface device, with a physical activity tracking device to obtain movement information;
determining, using the at least one processor, whether a level of inactivity exceeds a threshold based on the interactions and the movement information; and
when the level of inactivity exceeds the threshold, adjusting, using the at least one processor, access to multimedia content from the multimedia content provider in accordance with the level of inactivity.

9. The method of claim 8, wherein the physical activity tracking device includes at least one of a camera and a motion detector.

10. The method of claim 8, further comprising displaying, using the at least one processor, feedback information regarding the level of inactivity.

11. The method of claim 8, wherein adjusting access to multimedia content further comprises restricting, using the at least one processor, access to the multimedia content until the level of inactivity falls below the threshold.

12. The method of claim 8, wherein tracking the continuous interactions further comprises tracking, using the at least one processor, a time duration of video playback.

13. The method of claim 8, wherein tracking the continuous interactions further comprises tracking, using the at least one processor, a number of program episodes played back.

14. The method of claim 8, wherein the threshold is configurable based at least partially on demographic data or customized data.

15. A non-transitory computer readable medium with instructions stored therein which upon execution cause at least one processor to:
track interactions with a multimedia content provider;
communicate, using an interface, with a physical activity tracking device to obtain movement information;
determine whether a level of inactivity exceeds a threshold based on the interactions and the movement information; and
when the level of inactivity exceeds the threshold, adjust access to multimedia content from the multimedia content provider in accordance with the level of inactivity.

16. The non-transitory computer readable medium of claim 15, wherein the physical activity tracking device includes at least one of a camera and a motion detector.

17. The non-transitory computer readable medium of claim 15, wherein the instructions stored therein further cause the at least one processor to display feedback information regarding the level of inactivity.

18. The non-transitory computer readable medium of claim 15, wherein the instructions stored therein further cause the at least one processor to limit access to the multimedia content until the level of inactivity falls below the threshold so as to adjust access to the multimedia content.

19. The non-transitory computer readable medium of claim 15, wherein the instructions stored therein further cause the at least one processor to track a time duration of video playback so as to track the interactions.

20. The non-transitory computer readable medium of claim 15, wherein the instructions stored therein further cause the at least one processor to track a number of program episodes played back so as to track the continuous interactions.

21. The non-transitory computer readable medium of claim 15, wherein the threshold is configurable based at least partially on demographic data or customized data.
